(19) United States
(12) Patent Application Publication
(10) Pub. No.: US 2006/0151376 A1
(43) Pub. Date: Jul. 13, 2006

(54) Water filter apparatus

(76) Inventors: R. Wayne Tubbs, Mebane, NC (US); Judy V. Tubbs, Mebane, NC (US)

Correspondence Address: JENKINS, WILSON, TAYLOR & HUNT, P. A., 3100 TOWER BLVD, SUITE 1200, DURHAM, NC, 27707, US

(21) Appl. No.: 11/314,815

(22) Filed: Dec. 21, 2005

Related U.S. Application Data
(60) Provisional application No. 60/638,619, filed on Dec. 23, 2004.

(51) Int. Cl. B01D 29/00

(52) U.S. Cl. 210/335

(57) ABSTRACT

A water filter apparatus for use in filtering particles out of a water supply is provided. The apparatus includes a filter housing having a proximal end and a distal end, wherein the proximal end is adapted to be connected with an upstream water supply. The apparatus also includes a filter housing cap having a proximal end and a distal end, wherein the proximal end of the filter housing cap is adapted to be operatively connected with the distal end of the filter housing and the distal end of the filter housing cap is adapted to be connected with a downstream water supply. The apparatus additionally includes an inner filter assembly provided within the filter housing and includes a pre-screen filter and a filter cartridge fluidly connected to the pre-screen filter and including a plurality of filter media units.

### RELATED APPLICATIONS

This application claims the benefit of U.S. Provisional Patent Application Ser. No. 60/638,619, filed Dec. 23, 2004; the disclosure of which is incorporated herein by reference in its entirety.

### TECHNICAL FIELD

The present invention relates generally to water filters, and more particularly, to water filter apparatuses for use in filtering particles out of a water supply source.

### BACKGROUND ART

In the prior art, water filters to physically remove solid matter or suspended impurities, such as sand or other sediment, are well-known. Most filtration systems deal with whole house filtration, some appliance filtration, or filtration of drinking water. Even with a whole house filter system, sediment typically still gets through the water system and can clog downstream devices, such as clothes washing machines and lawn sprinklers, that utilize the water supply.

One of the main problems with sediment occurs in the water inlet valve on a clothes washing machine. Typically, the only filtration on a washing machine is an inlet valve screen which is a permanent filter screen designed to collect sediment from a water supply flow and which is located behind the washing machine on the cold water inlet valve (where a cold water supply hose connects). When this screen gets sediment buildup, the cold water flow typically decreases or can stop altogether. This water restriction can increase the time required to complete a wash cycle or can distort the water temperature in the wash cycle. In order to clean this screen, a user typically must cut off the water supply, pull the washing machine away from the wall, and disconnect the cold water supply hose from the water inlet valve. The screen is then removed and cleaned, the screen is replaced, the hose is reconnected, and the washing machine is pushed back into place and the water turned back on. This is a very time consuming and aggravating chore, which in some situations (such as in homes on well water) must be performed as often as monthly.

Another problem with the removal of the washing machine inlet valve screen is that occasionally the screen is damaged during the removal and/or cleaning process. If damaged, the screen may allow sediment through wherein the sediment may get caught in the inlet valve solenoid, which controls the water supply line that is connected to the washing machine. A grain of sand or other sediment caught between a water valve and its solenoid valve seat in a washing machine is sufficient to prevent the water valve from fully seating, with consequential water leakage and possible washing machine overflow.

Various United States patent documents are representative of the prior art and illustrate filters that have been previously employed with water supply lines.

U.S. Patent Application Publication No. 2005/0072725 to Swanson is directed to an inline filter adapted for use along a water supply line, including flexible inlet and outlet connecting tubes and an intermediate filter body joined together by a pair of dual-diameter connecting fittings defining a flow passageway therethrough.

U.S. Pat. No. 6,494,325 to Mizrahi discloses a toilet water-line filter in which a mesh straining element is positioned within a housing which may be threaded by means of external wings intermediate the toilet fill valve and a flexible supply line.

U.S. Pat. No. 5,223,136 to Gilbert and U.S. Pat. No. 5,992,643 to Scrogham et al. disclose filters which are mounted within rigid elongate pipes that are attached inline with supply lines.

The use of flexible hoses with filters are shown in U.S. Pat. No. 5,078,862 to Justice wherein a lint trap filter is employed in a washing machine drain hose and U.S. Pat. No. 3,685,657 to Hunter et al. wherein the fabric covering acts as a strainer.

U.S. Pat. No. 4,863,591 to Dionne is directed to an inline filter, mounted and disposed inline with respect to an incoming water supply line for a washing machine or lawn sprinkler, to filter out sand, dirt, particles and other debris from water flowing through the supply line.

U.S. Pat. No. 4,609,459 to Hendrix describes a filter apparatus, having a hollow, T-shaped, rigid body, which may be connected along a water line and has filter elements which may be interchanged or replaced.

U.S. Pat. No. 4,604,202 to Movshovits is directed to a mesh-type filter which may be threaded onto the end of a faucet or nozzle.

U.S. Pat. No. 4,263,140 to Wujnovich et al. describes an in-line fluid filter of the multi-piece type having a pair of body sections coaxially secured to each other.

U.S. Pat. No. 4,178,250 to Turetsky discloses a filter-purifier cartridge having a hollow core containing purifying medium and a surrounding filter element with fluid passing through the purifier medium and the filter element.

U.S. Pat. No. 4,062,781 to Strauss et al. describes a disposable filter unit which comprises a small, easily fabricated, glass-fiber filter tube unit.

U.S. Pat. No. 948,311 to Collin is directed to a water strainer attachable to the helical threads of a conventional outdoor faucet or bib.

U.S. Pat. No. 758,150 to Schilling is directed to a straining device attachable to a water inlet pipe with a two-part strainer having a wire screen of coarse mesh and one downstream of very fine mesh. The nipples at the inlet and outlet ends are provided with ordinary unions to allow connection along the water line.

While the prior art references described above have attempted to solve the aforementioned problems associated with the presence of sediment in water supply systems, they typically have not allowed for graduated removal of sediment of various sizes within a single unit and/or have not provided a user-friendly device that allows for replacement of the filter in a quick and cost-efficient manner. The present invention was designed to provide a water filter apparatus for the graduated removal of varying sized sediment from a water supply source without the costly or time-consuming processes or devices used in the prior art.

### DISCLOSURE OF THE INVENTION

A water filter apparatus for use in filtering particles out of a water supply is provided. The apparatus comprises a filter housing having a proximal end and a distal end, wherein the proximal end is adapted to be connected with an upstream water supply. The apparatus also comprises a filter housing cap having a proximal end and a distal end, wherein the proximal end of the filter housing cap is adapted to be operatively connected with the distal end of the filter housing and the distal end of the filter housing cap is adapted to be connected with a downstream water supply. The apparatus additionally comprises an inner filter assembly provided within the filter housing and comprising a pre-screen filter and a filter cartridge fluidly connected to the pre-screen filter and comprising a plurality of filter media units.

It is therefore an object to provide a water filter apparatus for use in filtering particles out of a water supply source, such as a water supply feeding a washing machine.

An object having been stated hereinabove, and which is achieved in whole or in part by the invention disclosed herein, other objects will become evident as the description proceeds when taken in connection with the accompanying drawings as best described hereinbelow.

### BRIEF DESCRIPTION OF THE DRAWINGS

FIG. 1 is an exploded perspective view of a water filter apparatus provided in accordance with the present invention disclosed herein;

FIG. 2 is an exploded side elevation view of the water filter apparatus illustrated in FIG. 1 and including a series of graduated filter media units and a filter cartridge removal protrusion;

FIG. 3 is a side elevation view of an assembled version of the water filter apparatus illustrated in FIGS. 1 and 2;

FIG. 4 is a side elevation cutaway view of the water filter apparatus illustrated in FIG. 3 and including a series of graduated filter media units;

FIG. 5 is a side elevation cutaway view of the water filter apparatus illustrated in FIG. 3 and including a filter cartridge removal protrusion; and

FIG. 6 is a photograph depicting placement of the water filter apparatus of the present invention in between a cold water supply source and a conventional washing machine.

### DETAILED DESCRIPTION OF THE INVENTION

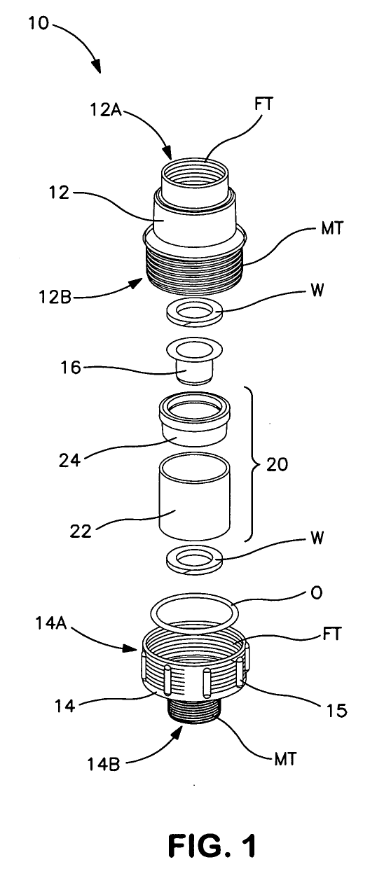

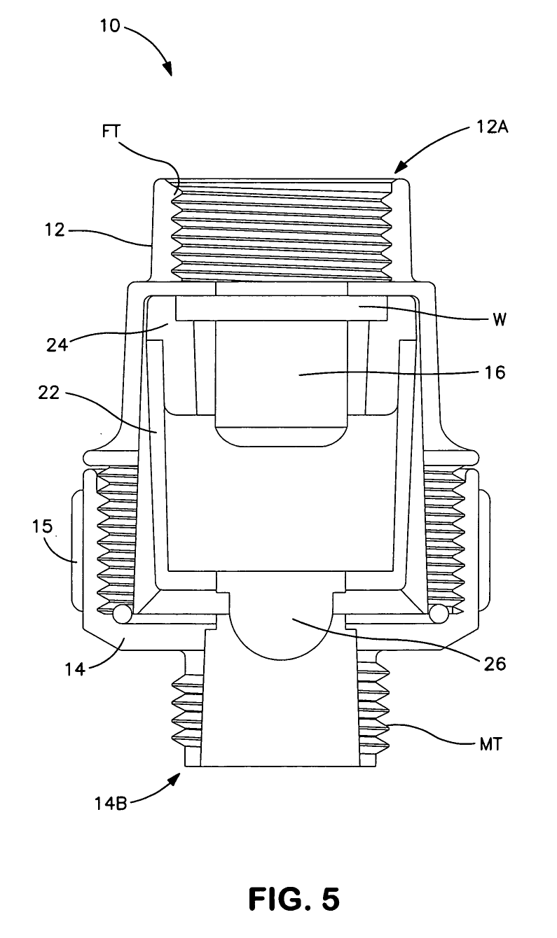

Referring to the drawings, particularly FIGS. 1-5, a water filter apparatus, generally designated 10, for filtering particles (e.g., sediment) out of a water supply source will now be described. Water filter 10 is shown to include a filter housing 12 and a filter housing cap 14. Filter housing 12 and filter housing cap 14 can be constructed of any suitable material, such as injection-molded polyvinyl chloride (PVC) plastic or the like, wherein the material constructs can be substantially transparent or substantially opaque.

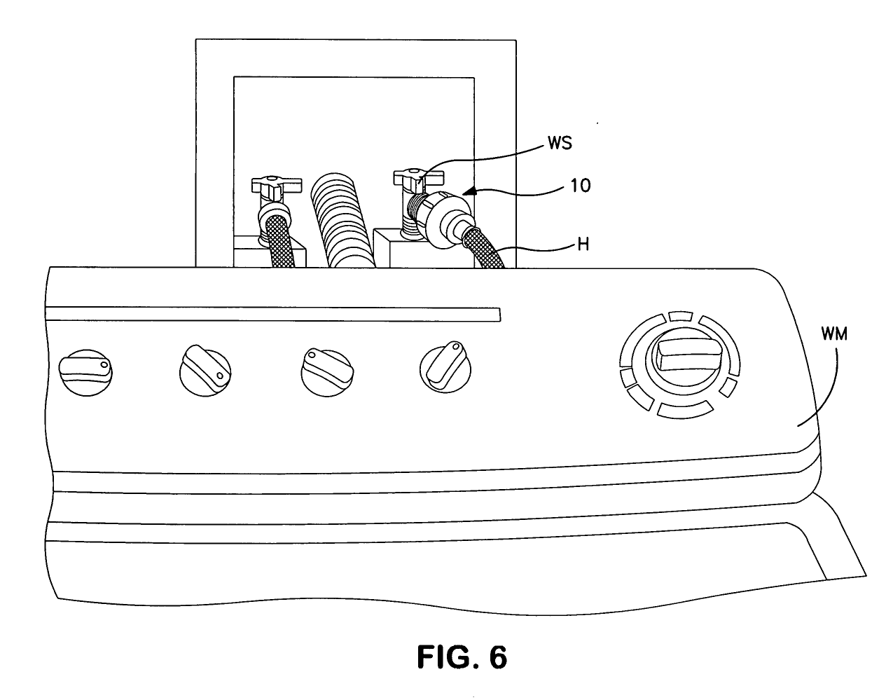

Filter housing 12 has a proximal end 12A and a distal end 12B wherein the cross-sectional area of distal end 12B is relatively larger than the cross-sectional area of proximal end 12A. Proximal end 12A is adapted to be connected with an upstream water supply source, such as cold water supply WS (see FIG. 6), and can contain threads therein, such as female threads FT shown in FIG. 1, or other type of arrangement to promote engagement with the upstream water supply source. Distal end 12B can contain threads thereon, such as male threads MT shown in FIG. 1, or other type of arrangement to promote engagement with filter housing cap 14 as is described below.

Filter housing cap 14 has a proximal end 14A and a distal end 14B wherein the cross-sectional area of proximal end 14A is relatively larger than the cross-sectional area of distal end 14B. Filter housing cap proximal end 14A can contain threads therein, such as female threads FT shown in FIG. 1, for the mating engagement with filter housing distal end 12B. Additionally, filter housing cap distal end 14B is adapted to be connected with a downstream water supply, such as hose H (see FIG. 6) and can include threads thereon, such as male threads MT shown in FIG. 1, or other arrangement for engagement with the downstream water supply. The downstream water supply, such as hose H (see FIG. 6), can then supply a downstream device (e.g., washing machine) with filtered water. Filter housing cap 14 can further include a plurality of external ribs 15 which extend radially outward from proximal end 14A. External ribs 15 can assist the user in gripping filter housing cap 14 during the installational engagement with filter housing 12 when forming the assembled unit. It is additionally understood that filter housing 12 may also include a plurality of external ribs (not shown) for a similar purpose.

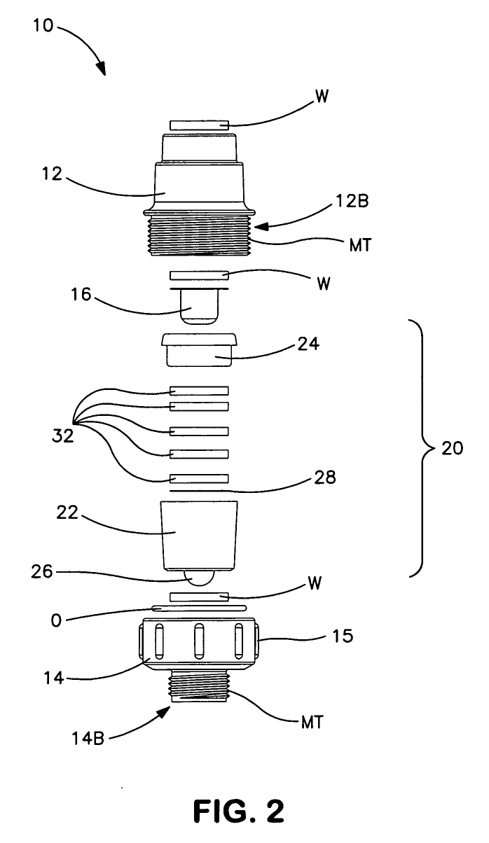

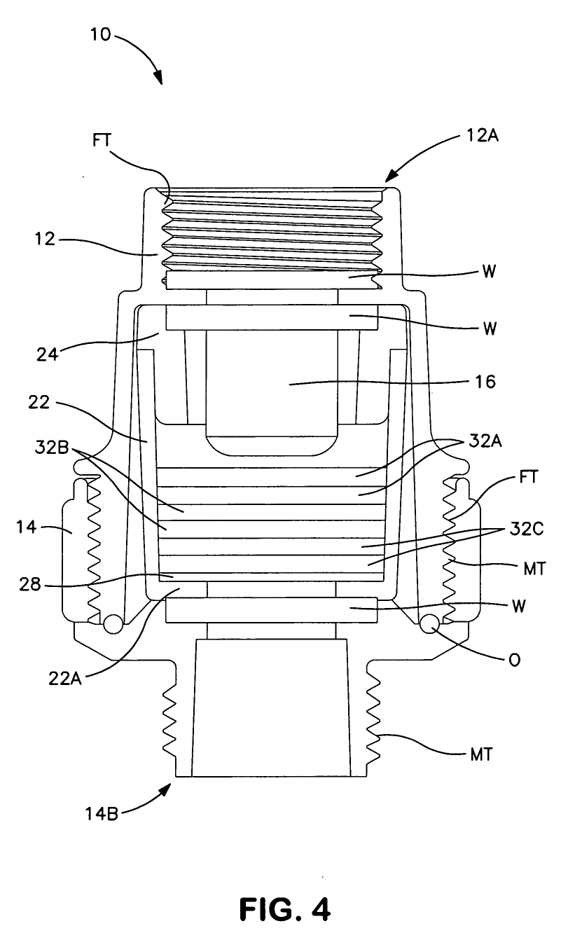

Water filter apparatus 10 further includes multiple inner filter components which are housed within filter housing 12 and filter housing cap 14 and which provide the capability to filter the water flowing through the device. A pre-screen filter 16 is provided which essentially consists of an inverted dome-shaped mesh basket and which provides filtering of the largest sediment particles contained in the water source. For example, pre-screen filter 16 can comprise a stainless steel basket made of 0.006/0.0065 wire which provides a 260 micron rated filtering capability to filter out sediment particles of 260 micron or larger size. Water filter apparatus 10 further includes a filter cartridge assembly shown generally as 20 which can be placed immediately downstream of pre-screen filter 16. Filter cartridge assembly 20 comprises a base 22 and a cap 24 and a plurality of filter media units 32 (see FIG. 2) which will be housed within filter cartridge base 22. Due the removable nature of filter cartridge assembly 20 from filter housing 12, filter cartridge base 22 can further include a protrusion 26 (see FIG. 2) which provides a gripping surface extending from filter housing 12 when installed to assist in gripping and removal of filter cartridge 20 from filter housing 12. Filter cartridge base 22 and cap 24 can be constructed of injection-molded PVC plastic or other suitable material. It is understood that pre-screen filter 16 and filter cartridge assembly 20 can be assembled (such as with washer W as shown in FIG. 4) in a removable unitary configuration (in permanent applications as described below) housed within filter housing 12 and filter housing cap 14.

Filter media units 32 contained within filter cartridge assembly 20 can consist of a graduated set of media units in order to filter particles of varying smaller sizes. For example, and shown in FIG. 4, media filter units 32 may suitably consist of a 100 micron rated filter unit set 32A to filter particles 100 micron or larger, a 10 micron rated filter unit set 32B to filter particles 10 micron or larger, and a 1 micron rated filter unit set 32C to filter particles 1 micron or larger. The graduated filtration enabled by pre-screened filter 16 through media filter units 32A, 32B, 32C allows for varying sized sediment particles to be filtered in different layers within water filter apparatus 10 such that the filtering life of the device is extended for a longer period of time than that which is provided by prior art screens of only one size. It is understood that media filter units 32 can be constructed of any suitable material which can provide the graduated filtering capabilities as described above. Such materials may include felt material (such as polyester non-woven fabric) or sponge material. Additionally, it is understood that the number of graduated filter media unit layers provided can be adjusted according to the specific water characteristics sought to be filtered (e.g., filter units sized of 200 micron, 100 micron, 50 micron, and 25 micron as tested and described below).

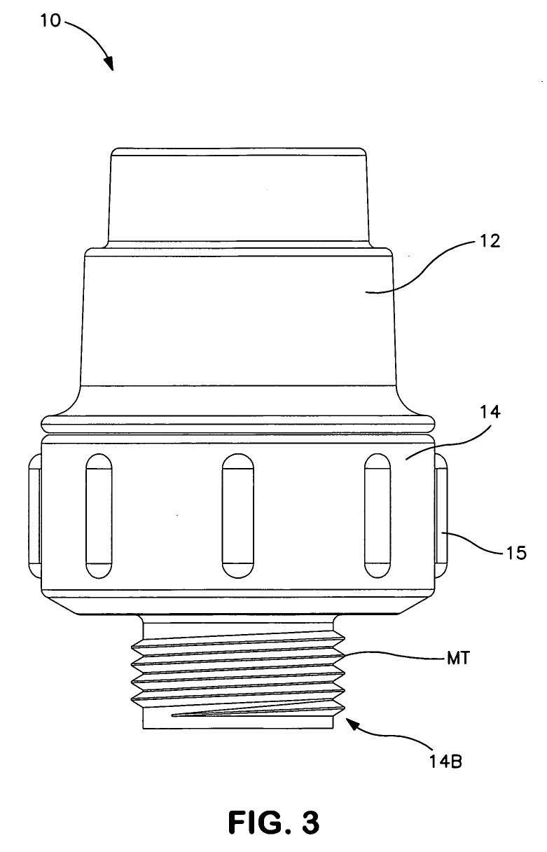

With reference to FIG. 3-5, the construction of water filter apparatus 10 will now be described. It is understood that water filter apparatus 10 can consist of a fully assembled disposable unit or a permanent unit that allows for replacement of pre-screen filter 16 and filter cartridge assembly 20 within water filter apparatus 10 by the end user of the device. As described above, water filter apparatus 10 generally consists of four injection-molded parts including filter housing 12, filter housing cap 14, and filter cartridge base 22 and cap 24 of filter cartridge assembly 20. Filter cartridge assembly 20 is housed within filter housing 12 and filter housing cap 14 and preferably is assembled along with pre-screen filter 16 (and washer W) as a single unit to be provided to the end user of water filter apparatus 10 (in permanent unit applications). In assembling filter cartridge 20, a filter screen support strainer 28 can be placed within the bottom of filter cartridge base 22, such as on shoulder 22A (see FIG. 4), for the supporting of filter media units 32. Varying graduated sized filter media units 32 can then placed within the bottom of filter cartridge base 22, on top of filter screen support strainer 28, in a diminishing manner as described above and filter cartridge cap 24 is placed on filter cartridge base 22 to form the complete filter cartridge assembly 20.

Pre-screen filter 16 (with washer W) can then be placed just upstream of filter cartridge assembly 20 and pre-screened filter 16 and filter cartridge 20 can be placed within filter housing 12 with associated washers W and o-rings O as needed for water-tight sealing of the unit. Filter housing cap 14 is then threadedly and matingly engaged with filter housing 12 thereby fully enclosing pre-screen filter 16 and filter cartridge assembly 20 as shown in FIG. 4. In disposable applications in which it is not desired for pre-screen filter 16 and filter cartridge assembly 20 to be removed and replaced, filter housing 12 and filter housing cap 14 may be permanently affixed, such as by using glue or the like. In a fully assembled configuration, water filter apparatus 10 can have a combined length in the range of approximately 2.5 to 3.0 inches and an outer diameter of approximately 1.5 inches.

In operation, and as shown in FIG. 6, water filter apparatus 10 can be placed in an inline position between an upstream water supply, such as cold water supply WS, and a downstream water supply, such as hose H, which is then fed to a downstream device, such as washing machine WM. To do so, for example, a user would thread filter housing proximal end 12A to the mating threads (not shown) located on water supply WS and would then thread filter housing cap distal end 14B onto mating threads (not shown) of hose H, wherein water flowing from water supply WS would pass through water filter apparatus 10 before entering hose H and washing machine WM. In such an arrangement, water flowing into washing machine WM will be filtered through pre-screen filter 16 and the graduated set of media filter units 32 within water filter apparatus 10, thereby providing substantially sediment-free water flowing into washing machine WM.

In order to determine the sediment removal capabilities of water filter apparatus 10, a test was conducted to determine the ability to remove total suspended solids (TSS) from a water source. The test was conducted using EPA Method 160.2, wherein a detection limit for TSS was placed at 5.0 mg/L. Tap water was spiked with a TSS concentration of 8.2 mg/L in order to reflect a relatively typical concentration of TSS found in real-life water samples. The spiked water sample was passed through water filter apparatus 10 having graduated media filter units 32 of 200 micron, 100 micron, 50 micron, and 25 micron, respectively, and the out flowing effluent water was collected and analyzed for TSS. Collected water that passed through water filter apparatus 10 was determined to have a TSS concentration below detectable limits.

As discussed above, it is understood that water filter apparatus 10 of the present invention can be constructed of particular materials and in such a manner so as to create a unitary unit that can be provided in a disposable form in which the entire water filter apparatus 10 is installed by the end user and replaced completely at periodic intervals. Alternatively, water filter apparatus 10 can be constructed in such a way that filter cartridge assembly 20 is removable from filter housing 12 and filter housing cap 14 and is replaceable by the end user. Additionally, it is understood that water filter apparatus 10 of the present invention is not limited to use with downstream devices such as washing machine WM, but could be used with any downstream device that would benefit from sediment removal, such as lawn sprinklers, power washers and the like. Further, it is understood that graduated media filter units 32A, 32B, 32C can be of substantially any size as may be required for efficacy in filtering water to washing machine WM or other apparatus to which filter apparatus 10 is attached.

It will be understood that various details of the invention may be changed without departing from the scope of the invention. Furthermore, the foregoing description is for the purpose of illustration only, and not for the purpose of limitation.

What is claimed is:

1. A water filter apparatus for use in filtering particles out of a water supply, the apparatus comprising:
(a) a filter housing having a proximal end and a distal end, wherein the proximal end is adapted to be connected with an upstream water supply;
(b) a filter housing cap having a proximal end and a distal end, wherein the proximal end of the filter housing cap is adapted to be operatively connected with the distal end of the filter housing and the distal end of the filter housing cap is adapted to be connected with a downstream water supply; and
(c) an inner filter assembly provided within the filter housing and comprising:
(i) a pre-screen filter; and
(ii) a filter cartridge fluidly connected to the pre-screen filter and comprising a plurality of filter media units.

2. The water filter apparatus according to claim 1 wherein the filter housing and filter housing cap are constructed of polyvinyl chloride (PVC) plastic.

3. The water filter apparatus according to claim 2 wherein the filter housing and filter housing cap are substantially transparent.

4. The water filter apparatus according to claim 2 wherein the filter housing and filter housing cap are substantially opaque.

5. The water filter apparatus according to claim 1 wherein the filter housing distal end cross-sectional area is relatively larger than the filter housing proximal end cross-sectional area and the filter housing cap proximal end cross-sectional area is relatively larger than the filter housing cap distal end cross-sectional area.

6. The water filter apparatus according to claim 1 wherein the filter housing and the filter housing cap have a combined length between about 2.5 to 3.0 inches when assembled.

7. The water filter apparatus according to claim 1 wherein the filter housing cap comprises a plurality of external ribs extending radially outward from the proximal end.

8. The water filter apparatus according to claim 1 wherein the pre-screen filter of the inner filter assembly defines and inverted dome-shape.

9. The water filter apparatus according to claim 8 wherein the pre-screen filter comprises a 260 micron rated filter to filter particles 260 micron or larger.

10. The water filter apparatus according to claim 1 wherein the filter cartridge of the inner filter assembly comprises a base having a protrusion that extends from the filter housing when assembled for removal of the filter cartridge from the filter housing.

11. The water filter apparatus according to claim 1 wherein the plurality of filter media units of the filter cartridge of the inner filter assembly comprise a graduated set of filter media units to filter particles of predetermined different sizes.

12. The water filter apparatus according to claim 11 wherein the graduated set of media units comprises consecutively a 200 micron rated unit to filter particles 200 micron or larger, a 100 micron rated unit to filter particles 100 micron or larger, a 50 micron rated unit to filter particles 50 micron or larger, and a 25 micron rated unit to filter particles 25 micron or larger.

13. The water filter apparatus according to claim 11 wherein the plurality of filter media units are constructed of a felt material.

14. The water filter apparatus according to claim 11 wherein the plurality of filter media units are constructed of a sponge material.

15. A water filter apparatus for use in filtering particles out of a water supply, the apparatus comprising:
(a) a filter housing constructed of substantially transparent polyvinyl chloride (PVC) plastic and having a proximal end and a distal end, wherein the proximal end is adapted to be connected with an upstream water supply;
(b) a filter housing cap constructed of substantially transparent polyvinyl chloride (PVC) plastic and having a proximal end and a distal end, wherein the proximal end of the filter housing cap is adapted to be operatively connected with the distal end of the filter housing and the distal end of the filter housing cap is adapted to be connected with a downstream water supply; and
(c) an inner filter assembly adapted to be housed within the filter housing and comprising:
(i) an inverted dome-shaped pre-screen filter; and
(ii) a filter cartridge fluidly connected to the pre-screen filter and comprising a plurality of filter media units to filter particles of predetermined different sizes.

16. The water filter apparatus according to claim 15 wherein the filter housing distal end cross-sectional area is relatively larger than the filter housing proximal end cross-sectional area and the filter housing cap proximal end cross-sectional area is relatively larger than the filter housing cap distal end cross-sectional area.

17. The water filter apparatus according to claim 15 wherein the filter housing and the filter housing cap have a combined length between about 2.5 to 3.0 inches when assembled.

18. The water filter apparatus according to claim 15 wherein the filter housing cap comprises a plurality of external ribs extending radially outward from the proximal end.

19. The water filter apparatus according to claim 15 wherein the pre-screen filter comprises a 260 micron rated filter to filter particles 260 micron or larger.

20. The water filter apparatus according to claim 15 wherein the filter cartridge of the inner filter assembly comprises a base having a protrusion that extends from the filter housing when assembled for removal of the filter cartridge from the filter housing.

21. The water filter apparatus according to claim 15 wherein the graduated set of media units comprises consecutively a 200 micron rated unit to filter particles 200 micron or larger, a 100 micron rated unit to filter particles 100 micron or larger, a 50 micron rated unit to filter particles 50 micron or larger, and a 25 micron rated unit to filter particles 25 micron or larger.

22. The water filter apparatus according to claim 15 wherein the plurality of filter media units are constructed of a felt material.

23. The water filter apparatus according to claim 15 wherein the plurality of filter media units are constructed of a sponge material.
